(19) United States
(12) Patent Application Publication
(10) Pub. No.: US 2026/0350258 A1
(43) Pub. Date: Nov. 5, 2026

(54) STATE TRANSITION MATRIX-BASED POWER SYSTEM SIMULATION

(71) Applicant: X Development LLC, Mountain View, CA (US)

(72) Inventors: Hamed Khalilinia, San Mateo, CA (US); Leo Francis Casey, San Francisco, CA (US)

(73) Assignee: X Development LLC, Mountain View, CA (US)

(21) Appl. No.: 19/724,473

(22) Filed: Jun. 29, 2026

Related U.S. Application Data
(63) Continuation of application No. PCT/US2024/060793, filed on Dec. 18, 2024.
(60) Provisional application No. 63/615,227, filed on Dec. 27, 2023.

(51) Int. Cl. G06F 30/18

(52) U.S. Cl. CPC G06F 30/18

(57) ABSTRACT

Methods, systems, and apparatus, including medium-encoded computer program products, for electrical power grid simulation. One of the methods includes obtaining a state-transition matrix model of an electrical power grid and executing a simulation of electric power grid behaviors by executing the state-transition matrix model using a parallel processing device that includes multiple cores.

### CROSS-REFERENCE TO RELATED APPLICATIONS

This application is a by-pass continuation of International Application No. PCT/US2024/060793, filed on Dec. 18, 2024, which claims priority to U.S. Provisional Application No. 63/615,227, filed on Dec. 27, 2023. The disclosures of the prior applications are considered part of and are incorporated by reference in the disclosure of this application.

### BACKGROUND

Electrical power grids transmit electrical power to loads such as residential and commercial buildings. Virtual models of an electrical grid can be used to simulate operations under various conditions. The complexity of modern electric grids due to increased use and distribution of renewable energy sources necessitates increased complexity in electric grid models and simulations. New simulation processes are needed in order to accurately and efficiently simulate such complex models.

### SUMMARY

This specification relates to improved simulation performance of electrical power grids. An electrical power grid includes one or more sources of electricity, one or more sinks, and mechanisms for distributing electrical power from the sources to the sinks. The simulation can be performed in the form of transient analysis for a pre-defined time range. During the transient analysis, each time dependent electrical element is discretized at each simulation time step. The transient analysis of each electric circuit provides one or more matrices of linear and/or nonlinear equations, which can be numerically or analytically solved for the state variables (e.g., voltages or currents at selected nodes) at each simulation time step.

In general, one innovative aspect of the subject matter described in this specification can be embodied in methods that include actions for electrical power grid simulation, the actions include: obtaining a state-transition matrix model of an electrical power grid, the state-transition matrix model defined with respect to (i) a plurality of state variables each representing a respective independent storage element of the electrical power grid, and (ii) a plurality of input variables each representing a respective power sink or power source element of the electrical power grid; executing a simulation of electric power grid behaviors by executing the state-transition matrix model using a parallel processing device that includes multiple cores, where executing the simulation comprises, at each of multiple simulation time steps: providing, to the multiple cores of the parallel processing device, a present value for each of one or more of the plurality of state variables; computing, at each one of the multiple cores and in parallel with others of the multiple cores, updated values for at least a subset of the plurality of input variables based on the present value for each of the one or more of the plurality of state variables; receiving, from the multiple cores of the parallel processing device, the updated values for the subset of the plurality of input variables; and a state of the state-transition matrix model based on computing an updated value for each of the plurality of state variables from the present value and based on the updated values for the subset of the plurality of input variables.

In some implementations, the state-transition matrix model of the electrical power grid includes a state matrix having entries representing respective coefficients of the plurality of state variables and an input matrix having entries representing respective coefficients of the plurality of state variables. In some implementations, computing, at each one of the multiple cores and in parallel with others of the multiple cores, the updated values for at least the subset of the plurality of input variables includes using a nonlinear solver. In some implementations, computing the updated value for each of the plurality of state variables includes computing the updated values using a linear solver. In some implementations, linear solver uses a Backward Euler technique to discretize the state-transition matrix model. In some implementations, the linear solver uses a Trapezoidal rule technique to discretize the state-transition matrix model. In some implementations, providing the present value for each of one or more of the plurality of state variables to the multiple cores of the parallel processing device includes, for each of one or more of the plurality of state variables: obtaining an initial value for the state variable; determining a predicted value for the state variable based on computing a matrix exponential of the state matrix; and providing the predicted value for the state variable as the present value for the state variable to a core of the parallel processing device. In some implementations, the multiple cores of the parallel processing device includes multiple processing units for matrix or vector computation.

Other implementations of this aspect include corresponding systems, apparatus, and computer programs, configured to perform the actions of the methods, encoded on computer storage devices.

Particular embodiments of the subject matter described in this specification can be implemented so as to realize one or more of the following advantages. During the process of developing or maintaining an electric power grid, the behavior of the grid is often simulated to verify correct behavior prior to installation of new assets or modifications to existing assets of the grid, thereby reducing the likelihood that errors related to the installations or modifications are introduced into the grid. The techniques described below can be used to more efficiently simulate the behavior of the electric power grid, such as transient stability of the grid.

Specifically, using the techniques described in this specification, the computations including computations for state-space equations that define a state-transition model of the grid-required during the process of electrical power grid simulation are executed efficiently using a parallel processing device, where each one of multiples cores of the parallel processing device concurrently, e.g., as opposed to sequentially, executes a sub-portion of the computations. Thus, electrical power grid simulation can be executed more quickly because the computations can be efficiently parallelized. Simulating the behavior of the electrical power grid may therefore require reduced wall clock time, and the computational efficiency of simulation process is therefore improved while overall simulation accuracy is maintained.

The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1 shows an example simulation system.

FIG. 2 shows an example illustration of an electrical power grid.

FIG. 3 shows an example illustration of operations performed at a particular simulation time step.

FIG. 4 is a flow diagram of an example process for simulating an electrical power grid.

FIG. 5 is a flow diagram of sub-steps of one of the steps of the process of FIG. 4, according to an implementation of the present disclosure.

FIG. 6 is a block diagram of an example computer system that can be used to perform operations described herein, according to an implementation of the present disclosure.

Like reference numbers and designations in the various drawings indicate like elements.

### DETAILED DESCRIPTION

Electrical power grids include a broad range of interconnected components that can be organized into two broad categories: transmission components that deliver power from power generation along high voltage wires across long distances to substations, and distribution components that distribute power from substations to endpoints such as homes and businesses. Some elements, such as substations, participate in both transmission and distribution. The components can be of various types such as inverters (Solar, Wind, HVDC, etc.), relays, Power Plant Controllers (PPCs), Energy Management Systems, Remedial Action Systems (RAS), Automatic Generator Controls, alarm systems and so on. The operation of one component often influences the operation of other components. For example, a PPC regulates and controls networked inverters within a power plant. In addition, various components can operate differently under different load conditions. Further, the output of one component can influence the load of other components. Understanding how the totality of components in the grid operate can aid in proper grid operation.

An electrical power grid can undergo additions and changes on a continual basis. New buildings, renewable power plants, stationary storage, mobile storage, and expansions to existing buildings, facilities, and loads are some examples of potential changes that can be proposed and made to existing electrical distribution feeders. Before new devices and systems are connected to the electrical power grid, it is often necessary to receive permission from the grid operator for the proposed changes. The grid operator ensures that the proposed changes are not likely to cause operation of the electrical distribution feeder to violate any limits or metrics that are put in place to ensure safe and reliable operation of the electrical power grid.

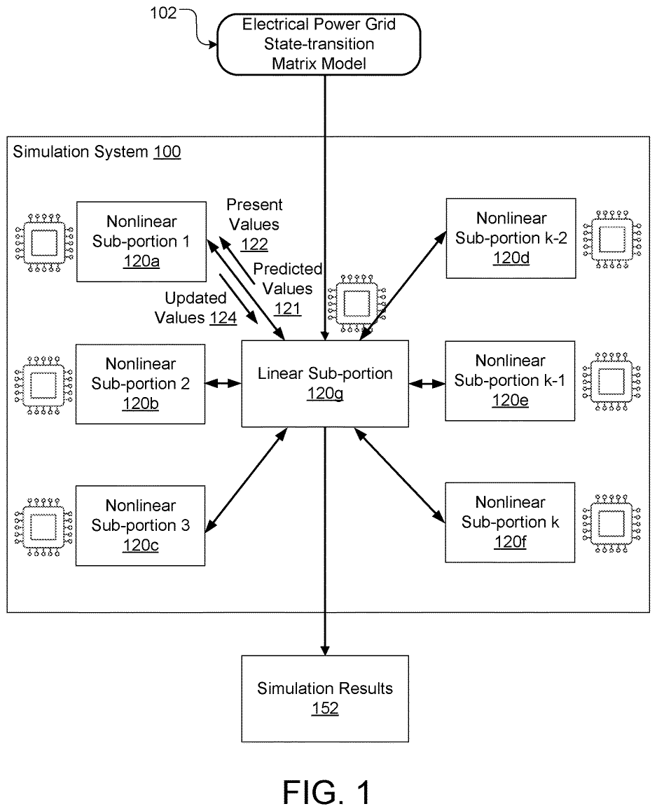

FIG. 1 shows an example electrical power grid simulation system 100. The electrical power grid simulation system 100 is an example of a system implemented as computer programs on one or more computers in one or more locations, in which the systems, components, and techniques described below can be implemented. The electrical power grid simulation system 100 can be used, for example, by grid operators, e.g., utilities. The system 100 can also be used by project developers, property owners, construction companies, and any other involved parties having interest in making additions and/or changes to an electrical power grid.

The electrical power grid simulation system 100 is implemented as least in part on a parallel processing device. The parallel processing device includes multiple cores 130a-g. Each core of the parallel processing device is a processing unit that can independently and, in parallel with other cores, execute computations involved in the simulation of an electrical power grid. The processing unit can be any type of processing unit suitable for linear algebra computations, including matrix or vector computations.

For example, each core of the parallel processing device can be a processor, e.g., a central processing unit (CPU), a graphics processing unit (GPU), or a custom processing unit configured as application-specific integrated circuit (ASIC) or field programmable gate array (FPGA). In this example, each core can be communicatively coupled to another core over a bus or interconnect (despite the cores might be located separately from each other, e.g., included on different boards).

As another example, the parallel processing device can be a multi-core processor, e.g., a multi-core CPU, a multi-core GPU, or a multi-core custom processing unit, and each core of the parallel processing device can be a core of the multi-core processor. In this example, in addition to being communicatively coupled to another core over a bus or interconnect, each core can, in fact, be integrated on the same package or chip as other cores of the parallel processing device.

As a high level, the electrical power grid simulation system 100 is a system that obtains data defining a state-transition matrix model 102 of an electrical power grid and executes a simulation of electric power grid behaviors by executing the state-transition matrix model 102 using the parallel processing device to generate the results 152 of the simulation.

For example, the system can execute a transient stability simulation of the electrical power grid by using the state-transition matrix model 102. Transient stability concerns the rotor angle stability for short-term dynamics and describes the ability of a grid to retain synchronism after a large disturbance occurs. Synchronicity of electrical power grids means that the resulting angular difference between all its generators remains within certain bounds after such a large disturbance, which are usually called contingencies and include for example different types of short circuits or the loss of generation and load buses.

In some implementations, the system can then output the results 152 of the simulation, e.g., data characterizing the time-domain simulation results, e.g., time-domain voltage, current, and active/reactive power responses. For example, the system can output the results 152 of the simulation to the user that provided the state-transition matrix model 102.

During execution, the electrical power grid simulation system 100 parallelizes the computations of the state-transition matrix model 102 that involve matrix operations, e.g., additions, subtractions, or multiplications involving a state matrix, an input matrix, or both, across the multiple cores of the parallel processing device to improve the efficiency of these computations. The improved computational efficiency enables the simulation results to be generated in reduced wall clock time, which enhances overall system performance.

The state-transition matrix model 102 is a software model that simulates the dynamics of operating the electrical power grid. The state-transition matrix model 102 can be generated locally at the system 100, or remotely at another system, by using any known method, e.g., a linear transformation method or a graph method, to model the transition between respective states of the electrical power grid at different time points. As a particular example, a state-transition matrix model can be generated from electric circuit data that describes an electric circuit of the electrical power grid by using the techniques described in more detail in commonly owned U.S. patent application Ser. No. 18/103,091, entitled “State Transition Matrix-Based Power System Simulation,” which is herein incorporated by reference.

In this particular example and many other examples, the state-transition matrix model 102 is defined with respect to a predetermined set of variables that collective represent an operating status of an electrical power grid. Each variable can have any value within a possible range of values associated with the variable. These variables can generally be categorized into state variables and input variables. Each state variable represents a respective independent storage element, e.g., a capacitor or an inductor, in an electric circuit of the electrical power grid. Each input variable represents a respective power sink element, e.g., a generator, or a respective power source element, e.g., a load, in the electric circuit of the electrical power grid.

To simulate the dynamics of operating the electrical power grid, the state-transition matrix model 102 defines, e.g., in the form of a first order matrix differential equation, the algorithmic relationship between potential outcomes (possible transition between different states over a given time interval) and these variables, which include those that represent independent storage elements, or “state variables,” and those that represent power sinks or power sources, or “input variables.”

It has been contemplated that, in some cases, certain elements, e.g., batteries and buildings with renewables, can be either a power sink element or a power source element. It has also been contemplated that, in some cases, an electrical power grid can include, as power sink elements (e.g., generators), one or more synchronous generators, one or more inverter-based resources, or a combination thereof and possibly other types of resources capable of modulating power (e.g., either real or reactive), including one or more battery-powered resources.

As used herein, synchronous generators include machinery that converts the mechanical power from a prime mover into electrical power at a particular voltage and frequency, and, that has an exciter capable of responding to excitation signals (e.g., auxiliary input signals). Examples of synchronous generators include gas turbines, hydroelectric synchronous generators, and the like. Inverter-based resources include generators that has a front-end controller that specifies an active current command (e.g., the component of the current that adjusts the real power output of the inverter). Alternatively, the front-end controller could specify a commanded voltage phasor (e.g., as in grid-forming inverters). Examples of inverter-based resources include photovoltaic solar panels, wind turbines, battery energy storage systems, and the like. Typically, inverter-based resources provide faster frequency response than synchronous generators.

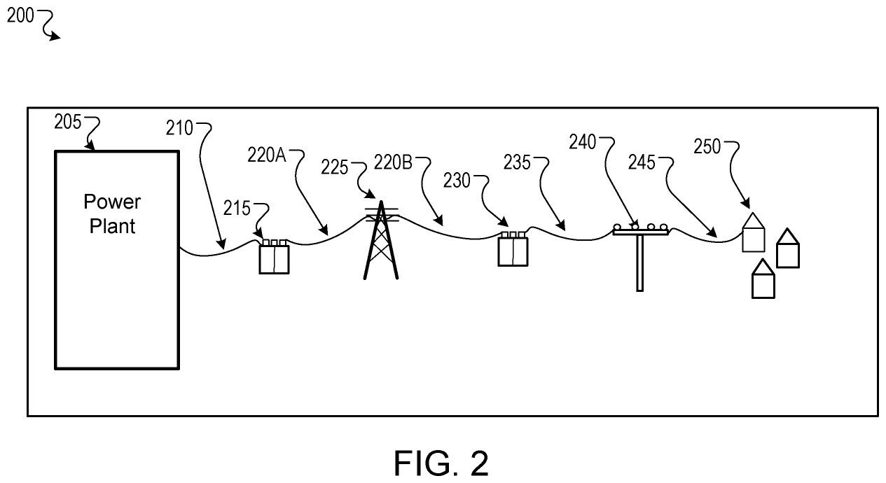

FIG. 2 shows an example illustration 200 of an electrical power grid. As illustrated, the electrical power grid includes a power plant 205 that houses one or more power sources, e.g., generators, and that is connected by a high voltage power line 210 to a distribution substation 215. The voltage of the output from the power plant 205 is stepped up for transmission on the high voltage power line 210. The distribution substation 215 is connected to a second substation 230 by high voltage power lines 220A, 220B that span a transmission tower 225. The second substation 230 can include a transformer that reduces voltage before delivering electricity across lower voltage power lines 235, 245 that span utility poles 245 and are connected to power sinks 250, e.g., end loads such as homes, apartments, businesses, etc.

Referring back to FIG. 1, the state-transition matrix model 102 can simulate the dynamics of operating the electrical power grid by evaluating a first order matrix differential equation in the form of:

\dot{X}=AX+BUᵢₙ,

where X is an n×1 state vector of n state variables, A is an n×n state matrix, B is an n×m input matrix, Uᵢₙ is a m×1 input vector of m input variables, and entries of the state vector X, state matrix A, input matrix B, and input vector Uᵢₙ can generally be determined from the variables and coefficients in set of network equations and a set of generator/load equations. The state matrix A is a matrix whose product with the state vector X at an initial time t gives state vector X at a later time t=t+1. Thus, during the simulation process, the electrical power grid simulation system 100 can represent the status of the electrical power grid at a given time as a state determined by using the state matrix A.

As described in more detail in the U.S. patent application Ser. No. 18/103,091 mentioned above, the set of network equations can include one or more capacitor state-space equations and/or inductor state-space equations that each include one or more state variables, and the set of generator/load equations can include one or more controlled current source state-space equations and/or controlled voltage source state-space equations that each include one or more input variables.

The dimensions of the state matrix and the input matrix generally increase as the scale of the electrical power grid grows. Therefore, when the electrical power grid is a large-scale grid, e.g., a grid within a large spatial region that includes thousands, millions, or more grid components, active loads and generators, the corresponding state matrix and input matrix will be very large matrices. A “large matrix” is a matrix of a dimension that is too large to be efficiently processed by a single core of the parallel processing device.

To ensure efficiency of the simulation process, the electrical power grid simulation system 100 thus partitions the large state matrix and input matrix into multiple smaller sub-matrices which have smaller dimensions, and, correspondingly, partitions the computations involving these matrices into multiple smaller sub-portions 120a-g. Compared with the original matrix computation, a sub-portion of the computation can be more efficiently processed by a single core because it involves fewer numbers of arithmetic operations.

Any of a variety of known techniques can be applied by the electrical power grid simulation system 100 to obtain the partitioned sub-matrices. For example, a Schur complement technique can be used.

As illustrated in FIG. 1, the electrical power grid simulation system 100 parallelizes the sub-portions 120a-g across the multiple cores 130a-g of the parallel processing device, such that during the simulation process, each one of the multiple cores independently execute a corresponding sub-portion of the computations in parallel with others of the multiple cores.

Each sub-portion of the computations generally involves updating the respective values for at least a subset of the state variables, a subset of the input variables, or both included in the state-transition matrix model 102. That is, each sub-portion involves computing the updated values 124 of at least some of these variables based on their present values 122 and on the predicted values 121 of the subset of the state variables. Through appropriate partition, the input variables are algebraically independent from the state variables, and the state variables can be used as the inputs to the network equations for computing the updated values for the input variables at each simulation time step.

Because the electrical properties of the loads and generators (which are represented by the input variables) adds non-linearities to the model, the system 100 can execute an instance of a nonlinear solver at each of the cores 130a-f Each of the cores 130a-f can use the corresponding instance of the nonlinear solver to execute a corresponding nonlinear sub-portion of the computations in order to compute, at each of multiple simulation time steps during the simulation process, the updated values 124 for the subset of the input variables from their present values 122 and based on the present values for the input variables.

A nonlinear solver can be used by each core 130a-f to determine a solution to a nonlinear equation, in which a change of an output is not proportional to a change of an input to the nonlinear equation, such as one of the generator/load equations. For example, the nonlinear solver can be an implicit or explicit numerical solver that implements a forward or backward Euler method to numerically solve the set of generator/load equations.

On the other hand, for sub-portions of the computations that involve the state variables that each represent a capacitor or an inductor, the computations are typically linear (at least for small time intervals, e.g., time intervals in the order of nanoseconds, milliseconds, or seconds). Thus, the system can execute a linear solver at the core 130g. The core 130g can use the linear solver to execute a corresponding linear sub-portion of the computations in order to compute, at each of multiple simulation time steps during the simulation process, updated values 124 for the state variables based on their present values 122 and on the updated values 124 for the input variables.

The linear solver can be used by the core 130g to determine a solution to a linear equation, in which a change of an output is proportional to a change of an input to the linear equation, such as one of the network equations. For example, the linear solver can implement a Backward Euler (BE) method or a Trapezoidal Rule (TR) method to discretize the state-transition matrix model 102 and numerically solve the set of network equations.

Each core of the multiple cores 130a-g can communicate the values for the variables to another core of the multiple cores 130a over a bus, an interconnect, or another data communication network. For example, in FIG. 1, the core 130g can communicate the present values 122 for a subset of the state variables to the core 130a, and, in response, receive the updated values 124 for the subset of the state variables that have been determined as a result of the core 130a executing a sub-portion of the computations based on the present values 122.

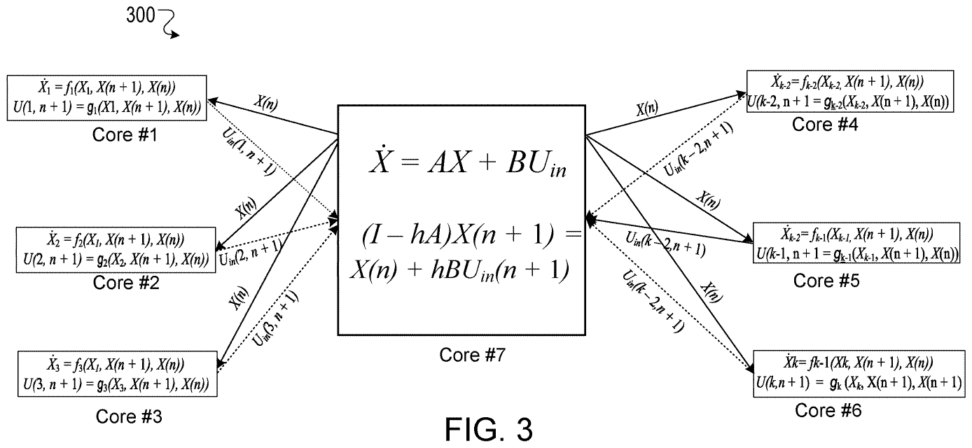

FIG. 3 shows an example illustration 300 of operations performed at a particular simulation time step n during the simulation process. As illustrated, the present values for the state variables X(n) are communicated from a core (core 7) to each of multiple cores (cores 1-6) of the parallel processing device. Each of the multiple cores 1-6 executes an instance of a nonlinear solver to determine the updated values for a distinct subset of the input variables, e.g., Uᵢₙ(1, n+1), Uᵢₙ(2, n+1), and so on until Uᵢₙ(k, n+1). To do so, each instance of the nonlinear solver is configured to evaluate a set of equations.

For example, a nonlinear solver executing at a core can evaluate the following equations using the present values for the state variables X(n) and, in some cases, the predicted values for the state variables X(n+1) to determine the update values for a first subset of the input variables Uᵢₙ(1, n+1):

\dot{X}₁=f₁(X₁,X(n+1),X(n)),

Uᵢₙ(1,n+1)=g₁(X₁,X(n+1),X(n)).

In this example, f₁ and g₁ are state space representations of a power sink element, e.g., a synchronous generator, f₁ represents the right-hand side of the ordinary differential equations (ODE) and g₁ is being used to calculate the output.

After the execution, each of the multiple cores 1-6 then communicates the updated values for the distinct subset of the input variables back to core 7 on which a linear solver is executed. The linear solver is configured to use the updated values for the input variables Uᵢₙ(n+1) to determine the updated values for the state variables X(n+1).

In the example of FIG. 3, the linear solver executing at core 7 uses a Backward Euler (BE) approach to determine the updated values for the state variables X(n+1). In the Backward Euler (BE) approach, the first order matrix differential equation \dot{X}=AX+BUᵢₙ can be discretized as bellow:

(I−hA)X(n+1)=X(n)+hBUᵢₙ(n+1),

where h is the step size that is dependent on the time interval between two consecutive simulation time steps during the simulation process. From this discretized equation, the updated values for the state variables X(n+1) can be determined in a computationally efficient manner.

In other examples, the linear solver executing at core 7 can use a different approach, e.g., the Trapezoidal Rule (TR) approach, or another implicit or semi-implicit method that is known. In the Trapezoidal Rule (TR) approach, for example, the first order matrix differential equation \dot{X}=AX+BUᵢₙ can be discretized as bellow:

$$( I - \frac{1}{2} hA ) X ( n + 1 ) = ( I + \frac{1}{2} hA ) X ( n ) + \frac{1}{2} nB ( {U}_{in} ( n ) + {U}_{in} ( n + 1 ) ) .$$

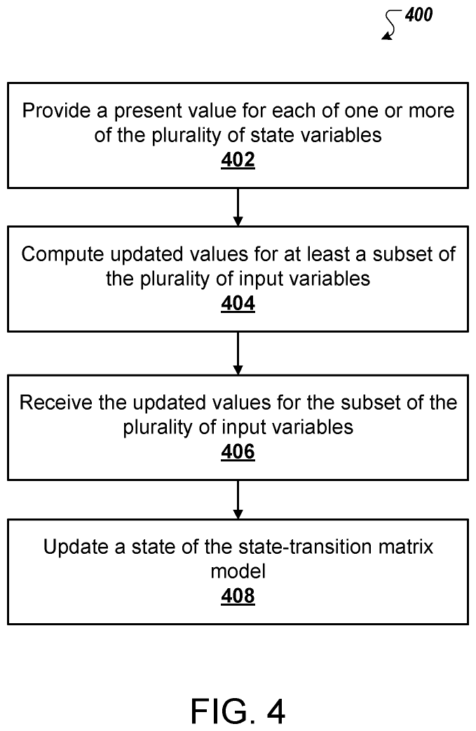

FIG. 4 is a flow diagram of an example process 400 for simulating an electrical power grid. For convenience, the process 400 will be described as being performed by a system of one or more computers located in one or more locations. For example, an electrical power grid simulation system, e.g., the electrical power grid simulation system 100 of FIG. 1, appropriately programmed, can perform the process 400. In this example, the system is implemented at least in part on a parallel processing device that includes multiple cores, where each core can independently and, in parallel with other cores, execute computations involved in the simulation of the electrical power grid.

In general, the system can obtain, i.e., receive or generate, a state-transition matrix model of an electrical power grid and then repeatedly perform the following steps 402-408 of the process 400 to execute a simulation of electric power grid behaviors by using the state-transition matrix model. During the simulation, the system can perform one iteration of steps 402-408 at each of multiple simulation time steps during the simulation process of the electrical power grid. The exact time length of each simulation time step is typically customizable, e.g., by a user of the system. For convenience of description, the simulation time step at each iteration will be referred to as the “present” simulation time step.

As discussed above, the state-transition matrix model is typically defined with respect to a plurality of state variables and a plurality of input variables. Each state variable represents a respective independent storage element of the electrical power grid. Each input variable represents a respective power sink or power source element of the electrical power grid.

For each of one or more of the plurality of state variables, the system provides a present value of the state variable at the present simulation time step to the multiple cores of the parallel processing device (step 402). Data representing the present values for the state variable can be transmitted, for example, over a bus, an interconnect, or another data communication network to arrive at the multiple cores.

Some power sink or power source elements, e.g., synchronous generators, have relatively slower changes in their states when in operation, and thus the states of the power sink or power source elements at the present simulation time step can be assumed to be approximately equal to the states of those elements at the previous simulation time step. Accordingly, in some cases, the previous values of these state variables that have been determined as of a preceding simulation time step are taken as the present value of the state variables at the present simulation time step.

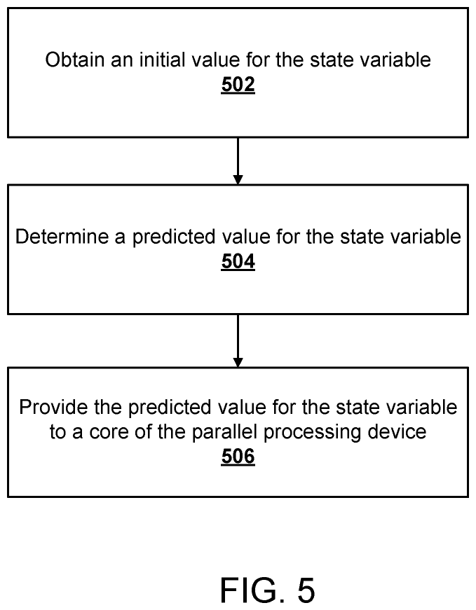

Some other power sink or power source elements, e.g., inverter-based resources, however, have relatively faster frequency responses. Accordingly, in some other cases, the system can additionally adopt a prediction step to determine the present values of the state variables at the present simulation time step, prior to sending them to the multiple cores of the parallel processing device. The prediction step will improve the overall accuracy of the simulation process. Performing step 402 with such a prediction step is explained in more detail with reference to FIG. 5, which shows sub-steps 502-506 corresponding to step 402.

FIG. 5 is a flow diagram of sub-steps of one of the steps of the process of FIG. 4. In general, the system can perform sub-steps 502-506 for each of one or more of the plurality of state variables.

The system obtains an initial value for the state variable (step 502). The initial value can be the previous values of the state variable that has been determined as of a preceding simulation time step.

The system determines a predicted value for the state variable (step 504). In one example, the system can do this by evaluating the following equation to determine the predicted values for the state variable:

Xₚ(n+1)=e^{AT}X(n)+KᵤₚU(n)

Kₙₚ=e^{AT}A⁻¹B−A⁻¹B,

where X(n) represents the state variables having the initial values, Xₚ(n+1) represents the state variables having the predicted values, and e^{AT} is the matrix exponential of the state matrix A, where T is the size of the time step, and Kₙₚ is a matrix which is a function of the matrix exponential e^{AT}, the inverse of matrix A, and matrix B. In another example, the system can instead do this by using a machine learning model configured to generate the predicted values for the state variables based on their initial values.

The system provides, as the present value, the predicted value for the state variable to one or more of the multiple cores of the parallel processing device (step 506). Optionally, the system also provides the initial value for the state variable to one or more of the multiple cores, such that for certain state variables, both the predicted value and the initial value for the state variables are provided to one or more of the multiple cores.

Upon receiving the present values for the state variables, the system computes, at each one of the multiple cores and in parallel with others of the multiple cores, updated values for at least a subset of the plurality of input variables (step 404). To compute the updated values based on the present value for the state variables, each core executes a nonlinear solver to execute a corresponding nonlinear sub-portion of the computations. Each nonlinear sub-portion generally involves evaluating one or more of the generator/load equations. In particular, each core can execute its corresponding nonlinear sub-portion of computations with some measure of concurrency with other cores.

The system receives, from the multiple cores of the parallel processing device, the updated values for the subset of the plurality of input variables (step 406). The updated values for the input variables are determined as a result of the concurrent execution of distinct sub-portions of the computations across the multiple cores of the parallel processing device. After the concurrent execution, each of the multiple cores can transmit data representing the updated values for the state variables, for example, over a bus, an interconnect, or another data communication network to another core.

The system updates a state of the state-transition matrix model based on computing an updated value for each of the plurality of state variables from their present values (step 408). To compute the updated values for the state variables based on the updated values for the input variables, a core in the parallel processing device executes a linear solver to execute a corresponding linear sub-portion of the computations. The linear sub-portion generally involves evaluating one or more of the network equations.

Since the linear sub-portion is executed subsequent to the nonlinear sub-portions, the linear sub-portion can be executed either on one of the multiple cores on which respective instances of a nonlinear solver were executed, or can alternatively be executed at a different core that is not included in any of the multiple cores.

After updating the state of the state-transition matrix model, the system determines whether a simulation termination criterion is met. For example, the system can determine that a simulation termination criterion is met if a predetermined number of iterations of the process 400 have been performed or if a predetermined period of time has elapsed since the beginning of the simulation process. In response to determining that a simulation termination criterion is met, the system can output the results of the simulation, e.g., data characterizing the time-domain simulation results, e.g., time-domain voltage, current, and active/reactive power responses. Alternatively, in response to determining that a simulation termination criterion is not met, the system can return to step 402 and perform another simulation iteration, and the updated values for the state variables will be used in the state-transition matrix model for the next simulation time step.

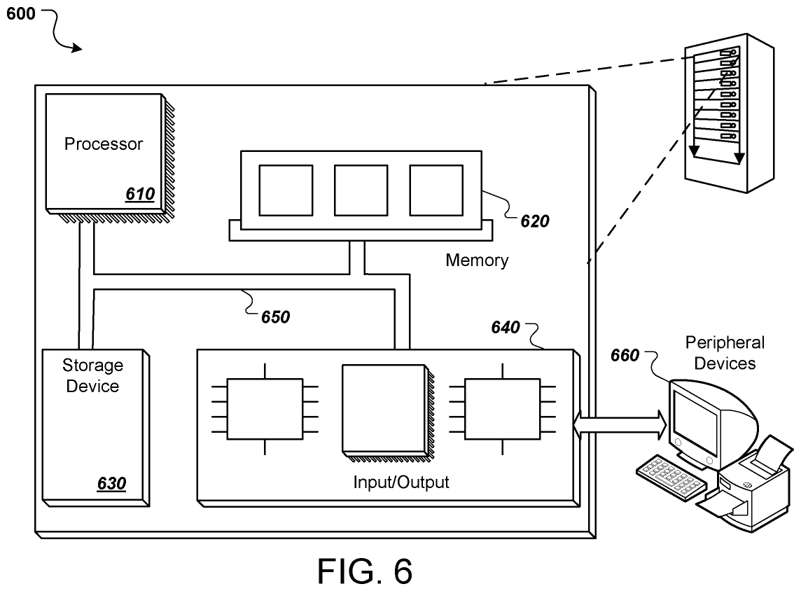

FIG. 6 is a block diagram of an example computer system 600 that can be used to perform operations described above, according to an implementation of the present disclosure. The system 600 includes a processor 610, a memory 620, a storage device 630, and an input/output device 640. Each of the components 610, 620, 630, and 640 can be interconnected, for example, using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 can include, for example, a hard disk device, an optical disk device, a storage device that is shared over a network by multiple computing devices (e.g., a cloud storage device), or some other large capacity storage device.

The input/output device 640 provides input/output operations for the system 600. In one implementation, the input/output device 640 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other devices, e.g., keyboard, printer, display, and other peripheral devices 660. Other implementations, however, can also be used, such as mobile computing devices, mobile communication devices, set-top box television client devices, etc.

Although an example processing system has been described in FIG. 6, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document (which for brevity will simply be referred to as a document) does not necessarily correspond to a file. A document may be stored in a portion of a file that holds other documents, in a single file dedicated to the document in question, or in multiple coordinated files.

For situations in which the systems discussed here collect and/or use personal information about users, the users may be provided with an opportunity to enable/disable or control programs or features that may collect and/or use personal information (e.g., information about a user's social network, social actions or activities, a user's preferences, or a user's current location). In addition, certain data may be treated in one or more ways before it is stored or used, so that personally identifiable information associated with the user is removed. For example, a user's identity may be anonymized so that the no personally identifiable information can be determined for the user, or a user's geographic location may be generalized where location information is obtained (such as to a city, ZIP code, or state level), so that a particular location of a user cannot be determined.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

This document refers to a service apparatus. As used herein, a service apparatus is one or more data processing apparatus that perform operations to facilitate the distribution of content over a network. The service apparatus is depicted as a single block in block diagrams. However, while the service apparatus could be a single device or single set of devices, this disclosure contemplates that the service apparatus could also be a group of devices, or even multiple different systems that communicate in order to provide various content to client devices. For example, the service apparatus could encompass one or more of a search system, a video streaming service, an audio streaming service, an email service, a navigation service, an advertising service, a gaming service, or any other service.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method for electrical power grid simulation, the method comprising:
obtaining a state-transition matrix model of an electrical power grid, the state-transition matrix model defined with respect to (i) a plurality of state variables each representing a respective independent storage element of the electrical power grid, and (ii) a plurality of input variables each representing a respective power sink or power source element of the electrical power grid;
executing a simulation of electric power grid behaviors by executing the state-transition matrix model using a parallel processing device that includes multiple cores, wherein executing the simulation comprises, at each of multiple simulation time steps:
providing, to the multiple cores of the parallel processing device, a present value for each of one or more of the plurality of state variables;
computing, at each one of the multiple cores and in parallel with others of the multiple cores, updated values for at least a subset of the plurality of input variables based on the present value for each of the one or more of the plurality of state variables;
receiving, from the multiple cores of the parallel processing device, the updated values for the subset of the plurality of input variables; and
updating a state of the state-transition matrix model based on computing an updated value for each of the plurality of state variables from the present value and based on the updated values for the subset of the plurality of input variables.

2. The method of claim 1, wherein the state-transition matrix model of the electrical power grid comprises a state matrix having entries representing respective coefficients of the plurality of state variables and an input matrix having entries representing respective coefficients of the plurality of state variables.

3. The method of claim 1, wherein computing, at each one of the multiple cores and in parallel with others of the multiple cores, the updated values for at least the subset of the plurality of input variables comprises using a nonlinear solver.

4. The method of claim 1, wherein computing the updated value for each of the plurality of state variables comprises computing the updated values using a linear solver.

5. The method of claim 4, wherein the linear solver uses a Backward Euler technique to discretize the state-transition matrix model.

6. The method of claim 4, wherein the linear solver uses a Trapezoidal rule technique to discretize the state-transition matrix model.

7. The method of claim 2, wherein providing the present value for each of one or more of the plurality of state variables to the multiple cores of the parallel processing device comprises, for each of one or more of the plurality of state variables:
obtaining an initial value for the state variable;
determining a predicted value for the state variable based on computing a matrix exponential of the state matrix; and
providing the predicted value for the state variable as the present value for the state variable to a core of the parallel processing device.

8. The method of claim 1, wherein the multiple cores of the parallel processing device comprise multiple processing units for matrix or vector computation.

9. A system comprising a parallel processing device and one or more storage devices storing instructions that when executed by the parallel processing device cause the parallel processing device to perform operations for electrical power grid simulation, wherein the operations comprise:
obtaining a state-transition matrix model of an electrical power grid, the state-transition matrix model defined with respect to (i) a plurality of state variables each representing a respective independent storage element of the electrical power grid, and (ii) a plurality of input variables each representing a respective power sink or power source element of the electrical power grid;
executing a simulation of electric power grid behaviors by executing the state-transition matrix model using the parallel processing device that includes multiple cores, wherein executing the simulation comprises, at each of multiple simulation time steps:
providing, to the multiple cores of the parallel processing device, a present value for each of one or more of the plurality of state variables;
computing, at each one of the multiple cores and in parallel with others of the multiple cores, updated values for at least a subset of the plurality of input variables based on the present value for each of the one or more of the plurality of state variables;
receiving, from the multiple cores of the parallel processing device, the updated values for the subset of the plurality of input variables; and
updating a state of the state-transition matrix model based on computing an updated value for each of the plurality of state variables from the present value and based on the updated values for the subset of the plurality of input variables.

10. The system of claim 9, wherein the state-transition matrix model of the electrical power grid comprises a state matrix having entries representing respective coefficients of the plurality of state variables and an input matrix having entries representing respective coefficients of the plurality of state variables.

11. The system of claim 9, wherein computing, at each one of the multiple cores and in parallel with others of the multiple cores, the updated values for at least the subset of the plurality of input variables comprises using a nonlinear solver.

12. The system of claim 9, wherein computing the updated value for each of the plurality of state variables comprises computing the updated values using a linear solver.

13. The system of claim 12, wherein the linear solver uses a Backward Euler technique to discretize the state-transition matrix model.

14. The system of claim 12, wherein the linear solver uses a Trapezoidal rule technique to discretize the state-transition matrix model.

15. The system of claim 10, wherein providing the present value for each of one or more of the plurality of state variables to the multiple cores of the parallel processing device comprises, for each of one or more of the plurality of state variables:
obtaining an initial value for the state variable;
determining a predicted value for the state variable based on computing a matrix exponential of the state matrix; and
providing the predicted value for the state variable as the present value for the state variable to a core of the parallel processing device.

16. The system of claim 9, wherein the multiple cores of the parallel processing device comprise multiple processing units for matrix or vector computation.

17. One or more computer-readable storage media storing instructions that when executed by a parallel processing device cause the parallel processing device to perform operations for electrical power grid simulation, wherein the operations comprise:
obtaining a state-transition matrix model of an electrical power grid, the state-transition matrix model defined with respect to (i) a plurality of state variables each representing a respective independent storage element of the electrical power grid, and (ii) a plurality of input variables each representing a respective power sink or power source element of the electrical power grid;
executing a simulation of electric power grid behaviors by executing the state-transition matrix model using the parallel processing device that includes multiple cores, wherein executing the simulation comprises, at each of multiple simulation time steps:
providing, to the multiple cores of the parallel processing device, a present value for each of one or more of the plurality of state variables;
computing, at each one of the multiple cores and in parallel with others of the multiple cores, updated values for at least a subset of the plurality of input variables based on the present value for each of the one or more of the plurality of state variables;
receiving, from the multiple cores of the parallel processing device, the updated values for the subset of the plurality of input variables; and
updating a state of the state-transition matrix model based on computing an updated value for each of the plurality of state variables from the present value and based on the updated values for the subset of the plurality of input variables.

18. The computer-readable storage media of claim 17, wherein the state-transition matrix model of the electrical power grid comprises a state matrix having entries representing respective coefficients of the plurality of state variables and an input matrix having entries representing respective coefficients of the plurality of state variables.

19. The computer-readable storage media of claim 17, wherein providing the present value for each of one or more of the plurality of state variables to the multiple cores of the parallel processing device comprises, for each of one or more of the plurality of state variables:
obtaining an initial value for the state variable;
determining a predicted value for the state variable based on computing a matrix exponential of the state matrix; and
providing the predicted value for the state variable as the present value for the state variable to a core of the parallel processing device.

20. The computer-readable storage media of claim 17, wherein the multiple cores of the parallel processing device comprise multiple processing units for matrix or vector computation.
